(19) United States
(12) Patent Application Publication
(10) Pub. No.: US 2025/0251308 A1
(43) Pub. Date: Aug. 7, 2025

(54) METHOD FOR PREDICTING VIBRATION RESPONSE AND STIFFNESS DEGRADATION OF HELICAL GEAR

(71) Applicant: Zhejiang University, Hangzhou City (CN)

(72) Inventors: Zheming TONG, Hangzhou City (CN); Shuiguang TONG, Hangzhou City (CN); Xianmiao YANG, Hangzhou City (CN)

(21) Appl. No.: 19/040,277

(22) Filed: Jan. 29, 2025

(30) Foreign Application Priority Data
Feb. 2, 2024 (CN) 202410150734.1

(51) Int. Cl. G01M 13/028; G06F 30/27; G06F 111/10

(52) U.S. Cl. CPC G01M 13/028; G06F 30/27; G06F 2111/10

(57) ABSTRACT

Provided is a method for predicting vibration response and stiffness degradation of a helical gear. The method includes: establishing a lumped parameter dynamic model of a gear system according to a meshing condition of a pair of gears, considering that the gear system is a multi-degree-of-freedom system under the action of a deterministic force and a random force, establishing a digital twin model of the system at multiple time scales of characteristic time and running time, calculating a translation-vibration coupling control equation, establishing a grey box model by combining unscented Kalman filter with machine learning, performing combined state parameter estimation upon collected data to construct a state prediction framework, and predicting stiffness degradation at a running time scale. Response of a nonlinear multi-degree-of-freedom system can be predicted, and the residual stiffness of the gear is predicted through the collected data.

### CROSS-REFERENCE TO RELATED APPLICATION

This patent application claims the benefit and priority of Chinese Patent Application No. 202410150734.1 filed with the China National Intellectual Property Administration on Feb. 2, 2024, the disclosure of which is incorporated by reference herein in its entirety as part of the present application.

### TECHNICAL FIELD

The present disclosure belongs to the field of auxiliary computing of gear performance, and in particular to a method for predicting vibration response and stiffness degradation of a helical gear.

### BACKGROUND

Gearbox is a key component in automobile, advanced manufacturing, wind turbine, aerospace and other industrial fields, with the advantages of compact structure and stable transmission performance. However, the gear runs under harsh conditions, such as inevitable speed fluctuation and variable load, which accelerates the degradation process of the gear. The health status of the gear directly affects the running performance and efficiency of the machine. In addition, the stiffness degradation of the gear is an inevitable degradation behavior in the whole gearbox life cycle. Therefore, evaluating the gear performance and the stiffness degradation process is of a practical significance for the predictive maintenance of gear transmission system. At present, the domestic and international research on dynamic response and stiffness degradation prediction of the nonlinear multi-degree-of-freedom system of the gear is scarce, and the representative research on stiffness degradation prediction is mainly in a single time scale or single degree of freedom, without considering the influence of multiple time scales and multiple degrees of freedom.

### SUMMARY

An objective of the present disclosure is to solve the problems in the prior art, and provides a method for predicting vibration response and stiffness degradation of a helical gear to predict the dynamic response and stiffness degradation of a nonlinear multi-degree-of-freedom system at different time scales.

To achieve the objective above, the technical solution adopted by the present disclosure is as follows:

A method for predicting vibration response and stiffness degradation of a helical gear includes the following steps:
S1: acquiring design parameters of a pair of intermeshing gears to be predicted, and then establishing a dynamic model of a helical gear meshing pair, and then establishing a digital twin model with the dynamic model as a nominal physical model, and introducing a Duffing oscillator into the digital twin model to simulate stochastic nonlinearity in a system, thereby establishing a translation-vibration coupling control equation;
S2: based on an unscented Kalman filter algorithm, estimating state parameters of displacement, speed and stiffness by using simulated acceleration data obtained from the translation-vibration coupling control equation to obtain an estimated value of each state parameter in an instantaneous time scale and an evolution process of stiffness in a running time scale; and
S3: training a machine learning model with evolution process data of the stiffness at the running time scale as training data, to form a stiffness state prediction model, which is configured to predict the stiffness degradation of the helical gear meshing pair in future.

In one embodiment, specific implementation steps of Step S1 are as follows:
S1-1: acquiring design parameters of the pair of intermeshing gears to be predicted, comprising a number of teeth of a gear, a module, a pressure angle, a helix angle, a contact ratio, a tooth width, a radius of base circle, a rated load, a rated speed, an input torque, and an output torque;
S1-2: establishing a lumped parameter dynamic model of an eight-degree-of-freedom helical gear system according to design parameters of the helical gear meshing pair and Newton's second law, and solving a meshing force of the helical gear system;
the dynamic model is as follows:

$$\{ \begin{matrix}{m}_{1} {\ddot{x}}_{1} ( t ) + {c}_{x 1} {\dot{x}}_{1} ( t ) + {k}_{x 1} {x}_{1} = - {\sum }_{j = 1}^{n} {F}_{mxj} ( t ) \\ {m}_{2} {\ddot{x}}_{2} ( t ) + {c}_{x 2} {\dot{x}}_{2} ( t ) + {k}_{x 2} {x}_{2} = - {\sum }_{j = 1}^{n} {F}_{mxj} ( t ) \\ {m}_{1} {\ddot{y}}_{1} ( t ) + {c}_{y 1} {\dot{y}}_{1} ( t ) + {k}_{y 1} {y}_{1} = 0 \\ {m}_{2} {\ddot{y}}_{2} ( t ) + {c}_{y 2} {\dot{y}}_{2} ( t ) + {k}_{y 2} {y}_{2} = 0 \\ {m}_{1} {\ddot{z}}_{1} ( t ) + {c}_{z 1} {\dot{z}}_{1} ( t ) + {k}_{z 1} {z}_{1} = - {\sum }_{j = 1}^{n} {F}_{mzj} ( t ) \\ {m}_{2} {\ddot{z}}_{2} ( t ) + {c}_{z 2} {\dot{z}}_{2} ( t ) + {k}_{z 2} {z}_{2} = {\sum }_{j = 1}^{n} {F}_{mzj} ( t ) \\ {I}_{1} {\ddot{θ}}_{1} + {\sum }_{j = 1}^{n} {F}_{mxj} ( t ) {R}_{b 1} - {T}_{1} = 0 \\ {I}_{2} {\ddot{θ}}_{2} - {\sum }_{j = 1}^{n} {F}_{mxj} ( t ) {R}_{b 2} + {T}_{2} = 0\end{matrix} ,$$

where xᵢ, yᵢ and zᵢ are translational displacements of a gear i in a direction of a meshing line, a direction perpendicular to the meshing line, and an axial direction, respectively; mᵢ is mass of the gear i, kₓᵢ, k_{yi} and k_{zi} are stiffness of the gear i in the direction of the meshing line, the direction perpendicular to the meshing line, and the axial direction, respectively; cₓᵢ, c_{yi} and c_{zi} are damping of the gear i in the direction of the meshing line, the direction perpendicular to the meshing line, and the axial direction, respectively; i=1, 2 represents a driving gear and a driven gear, respectively; Fₘₓⱼ(t) and F_{mzj}(t) are dynamic meshing forces of a j-th tooth meshed at time t in the direction of the meshing line and the axial direction, respectively; j=1, 2, . . . , n; n is the number of meshed teeth; I₁ and I₂ are moment of inertia of the driving wheel and the driven wheel, respectively; θ₁ and θ₂ are rotation angles of the driving wheel and the driven wheel, respectively; T₁ and T₂ are an input torque and an output torque, respectively, R_{b1} and R_{b2} are radii of base circles of the driving wheel and the driven wheel, respectively; and one point or two points on a parameter symbol represent a first derivative or a second derivative of the parameter, respectively;
S1-3: establishing a six-degree-of-freedom translation-vibration digital twin model of the helical gear system with the dynamic model as a nominal system of digital twin, which is in a form of:

$$M ( {τ}_{s} ) \frac{{\partial }^{2} X ( t , {τ}_{s} )}{\partial {t}^{2}} + C ( {τ}_{s} ) \frac{{\partial }^{2} X ( t , {τ}_{s} )}{\partial {t}^{2}} + K ( {τ}_{s} ) X ( t , {τ}_{s} ) + G ( t , {τ}_{s} ) = F ( t , {τ}_{s} ) + Ξ \dot{W} ,$$

where M(τₛ), C(τₛ) and K(τₛ) are a mass matrix, a damping matrix and a stiffness matrix of the gear, respectively, which are all related to running time τₛ; Ξ is a noise strength matrix, \dot{W} is a random load, G, F and X are stochastic nonlinearity, a meshing force and a translational displacement of the helical gear system, respectively, which are all related to instantaneous time t and the running time τₛ; and
S1-4: based on the six-degree-of-freedom translation-vibration digital twin model, adding a Duffing oscillator to the driven wheel in the direction perpendicular to the meshing line to simulate the stochastic nonlinearity G in the system, thus establishing the translation-vibration coupling control equation, which is in a form of:

$$\{ \begin{matrix}{m}_{1} {\ddot{x}}_{1} + ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} = - {\sum }_{j = 1}^{n} {F}_{mxj} + {ξ}_{1} {\dot{w}}_{1} \\ {m}_{2} {\ddot{x}}_{2} - {c}_{x 2} {\dot{x}}_{1} + ( {c}_{x 2} + {c}_{y 1} ) {\dot{x}}_{2} - {c}_{y 1} {\dot{y}}_{1} - {k}_{x 2} {x}_{1} + ( {k}_{x 2} + {k}_{y 1} ) {x}_{2} - {k}_{y 1} {y}_{1} = {\sum }_{j = 1}^{n} {F}_{mxj} + {ξ}_{2} {\dot{w}}_{2} \\ {m}_{1} {\ddot{y}}_{1} - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + ( {k}_{y 1} - {k}_{y 2} ) {y}_{1} - {k}_{y 2} {y}_{2} = {ξ}_{3} {\dot{w}}_{3} \\ {m}_{2} {\ddot{y}}_{2} - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + ( - {k}_{y 2} + {k}_{z 1} ) {y}_{2} - {k}_{z 1} {z}_{1} + {{α}_{do} ( {y}_{2} - {y}_{1} )}^{3} = {ξ}_{4} {\dot{w}}_{4} \\ {m}_{1} {\ddot{z}}_{1} - {c}_{z 1} {\dot{y}}_{2} + ( {c}_{z 1} + {c}_{z 2} ) {\dot{z}}_{1} - {c}_{z 2} {\dot{z}}_{2} - {k}_{z 1} {y}_{2} + ( {k}_{z 1} + {k}_{z 2} ) {z}_{1} - {k}_{z 2} {z}_{2} = - {\sum }_{j = 1}^{n} {F}_{mxj} + {ξ}_{5} {\dot{w}}_{5} \\ {m}_{2} {\ddot{z}}_{2} - {c}_{z 1} {\dot{z}}_{1} + {c}_{z 2} {\dot{z}}_{2} - {k}_{z 1} {z}_{1} + {k}_{z 2} {z}_{2} = {\sum }_{j = 1}^{n} {F}_{mzj} + {ξ}_{6} {\dot{w}}_{6}\end{matrix}$$

where α_{do} is a Duffing oscillator factor that simulates stochastic nonlinearity in the helical gear system, and ξₗ\dot{w}ₗ represents noise strength corresponding to the degree of freedom l, l=1, 2, . . . , 6.

In one embodiment, the design parameters of the helical gear are acquired from gear design data.

In one embodiment, the digital twin model has two different time scales, which are the instantaneous time t and the running time τₛ. A time step of the instantaneous time t is seconds, and a time step of the running time τs is days. The instantaneous time scale is used for state parameter estimation, and the running time scale is used for stiffness degradation prediction.

In one embodiment, specific implementation steps of Step S2 are as follows:
S2-1: establishing an acceleration equation based on the translation-vibration coupling control equation, acquiring simulated acceleration data of the helical gear by solving the acceleration equation, where the acceleration equation is represented as follows:

$$A = - [ \begin{matrix}\frac{1}{{m}_{1}} ( ( {c}_{x 1} + {c}_{x 2} ) {\dot{x}}_{1} - {c}_{x 2} {\dot{x}}_{1} + ( {k}_{x 1} + {k}_{x 2} ) {x}_{1} - {k}_{x 2} {x}_{2} ) \\ \frac{1}{{m}_{2}} ( - {c}_{x 2} {\dot{x}}_{1} + ( {c}_{x 2} + {c}_{y 1} ) {\dot{x}}_{2} - {c}_{y 1} {\dot{y}}_{1} - {k}_{x 2} {x}_{1} + ( {k}_{x 2} + {k}_{y 1} ) {x}_{2} - {k}_{y 1} {y}_{1} ) \\ \frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + ( {k}_{y 1} - {k}_{y 2} ) {y}_{1} + {k}_{y 2} {y}_{2} ) \\ \frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} + {k}_{y 2} {y}_{1} + ( - {k}_{y 2} + {k}_{z 1} ) {y}_{2} - {k}_{z 1} {z}_{1} + {{α}_{do} ( {y}_{2} - {y}_{1} )}^{3} ) \\ \frac{1}{{m}_{1}} ( - {c}_{z 1} {\dot{y}}_{2} + ( {c}_{z 1} + {c}_{z 2} ) {\dot{z}}_{1} - {c}_{z 2} {\dot{z}}_{2} - {k}_{z 1} {y}_{2} + ( {k}_{z 1} + {k}_{z 1} ) {z}_{1} - {k}_{z 2} {z}_{2} ) \\ \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix} ]$$

where in the expression, A represents simulated acceleration data in the matrix form;
S2-2: based on the obtained simulated acceleration data and the unscented Kalman filter algorithm, estimating the state parameters of displacement, speed and stiffness at different instantaneous time at the instantaneous time scale in an iterative manner by the “Euler-Maruyama” method, where a formula is as follows:

$${y}_{k + 1} = {y}_{k} + a ( {t}_{k + 1} , {y}_{k + 1} ) Δ t + b ( {t}_{k + 1} , {y}_{k + 1} ) Δ w ,$$

where y is a state space vector composed of a displacement, speed and stiffness, yₖ and yₖ₊₁ are state space vectors y corresponding to a previous instantaneous time tₖ and a following instantaneous time tₖ₊₁, respectively, and a time step of iteration is Δt=tₖ₊₁−tₖ; Δw is a variation amount of an independent Wiener process w between the previous instantaneous time and the following instantaneous time; a and b are a drift matrix and a diffusion matrix, respectively;
S2-3: constructing a stiffness degradation function at the running time scale, and then estimating the evolution process of stiffness at the running time scale in an iterative manner through an unscented Kalman filtering algorithm based on the stiffness attenuation function, where a form of the stiffness attenuation function is:

$$K ( {τ}_{s} ) = {K}_{0} {e}^{- {α}_{k} {τ}_{z}} \frac{( 1 + {ε}_{k} cos ( {β}_{k} {τ}_{s} ) )}{( 1 + {ε}_{k} )} ,$$

where K₀ is initial stiffness of the helical gear system. K(τₛ) is stiffness of the helical gear system in the running time τₛ, αₖ is a stiffness attenuation factor, and εₖ and βₖ are stiffness attenuation form coefficients.

In one embodiment, expressions of a drift matrix a and a diffusion matrix b are as follows:

$$a = [ \begin{matrix}{\dot{x}}_{1} \\ \frac{- {\sum }_{j = 1}^{n} {F}_{mxj}}{{m}_{1}} - \frac{1}{{m}_{1}} ( ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} ) \\ {\dot{x}}_{2} \\ \begin{matrix}\frac{- {\sum }_{j = 1}^{n} {F}_{mxj}}{{m}_{2}} - \frac{1}{{m}_{2}} ( - {c}_{x 2} {\dot{x}}_{1} + ( {c}_{x 2} + {c}_{y 1} ) {\dot{x}}_{2} - \\ {c}_{y 1} {\dot{y}}_{1} - {k}_{x 2} {x}_{1} + ( {k}_{x 2} + {k}_{y 1} ) {x}_{2} - {k}_{y 1} {y}_{1} )\end{matrix} \\ \begin{matrix}{\dot{y}}_{1} \\ \begin{matrix}- \frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} - {k}_{y 2} {y}_{2} )\end{matrix} \\ {\dot{y}}_{2}\end{matrix} \\ \begin{matrix}- \frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( - {k}_{y 2} + {k}_{z 1} ) {y}_{2} - {k}_{z 1} {z}_{1} + {{α}_{do} ( {y}_{2} - {y}_{1} )}^{3} )\end{matrix} \\ \begin{matrix}{\dot{z}}_{1} \\ \begin{matrix}\frac{- {\sum }_{j = 1}^{n} {F}_{mzj}}{{m}_{1}} - \frac{1}{{m}_{1}} ( - {c}_{z 1} {\dot{y}}_{2} + ( {c}_{z 1} + {c}_{z 2} ) {\dot{z}}_{1} - \\ {c}_{z 2} {\dot{z}}_{2} - {k}_{z 1} {y}_{2} + ( {k}_{z 1} + {k}_{z 2} ) {z}_{1} - {k}_{z 2} {z}_{2} )\end{matrix} \\ {\dot{z}}_{2}\end{matrix} \\ \frac{- {\sum }_{j = 1}^{n} {F}_{mzj}}{{m}_{2}} - \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix} ]$$

$$b = [ \begin{matrix}{0}_{1 \times 6} \\ \frac{{ξ}_{1}}{{m}_{1}} , {0}_{1 \times 5} \\ {0}_{1 \times 6} \\ 0 , \frac{{ξ}_{2}}{{m}_{2}} , {0}_{1 \times 4} \\ \begin{matrix}{0}_{1 \times 6} \\ {0}_{1 \times 2} , \frac{{ξ}_{3}}{{m}_{1}} , {0}_{1 \times 3} \\ {0}_{1 \times 6}\end{matrix} \\ {0}_{1 \times 3} , \frac{{ξ}_{4}}{{m}_{2}} , {0}_{1 \times 2} \\ \begin{matrix}{0}_{1 \times 6} \\ {0}_{1 \times 4} , \frac{{ξ}_{5}}{{m}_{1}} , 0 \\ {0}_{1 \times 6}\end{matrix} \\ {0}_{1 \times 5} , \frac{{ξ}_{6}}{{m}_{2}}\end{matrix} ] .$$

In one embodiment, a Gaussian process regression model is used as the machine learning model, an input of the Gaussian process regression model is the running time, and an output of the Gaussian process regression model is a predicted value of the stiffness.

Compared with the prior art, the present disclosure has the following beneficial effects:
1. A gap of the gear system in response prediction and stiffness degradation prediction at multi-degree-of-freedom and multiple time scales is filled, and the blindness of the traditional empirical calculation is overcome.
2. The digital twin model is established, and an unknown physical model is processed using a data driving model by using advantages of data drive and physical drive, the time evolution process of the system parameters is further estimated, which has strong generalization ability.
3. The algorithm provided by the present disclosure has two key components: an algorithm of joint estimation of input and state, and a machine learning algorithm of mapping estimation of state and input. In the present disclosure, the unscented Kalman filter algorithm is configured to jointly estimate the input and state vectors, and the mapping, between the state and the input, is estimated using Gaussian process regression learning, thus improving the accuracy and performance of the prediction algorithm.
4. The present disclosure does not attempt to replace a control equation with a machine learning model. On the contrary, machine learning is used to enhance a known approximate control equation, and thus can be better generalized to the unknown environment.
5. By using the response of the control equation prediction system, the response of all layers can be predicted by the measured data of one layer, and the influence of the noise is less.

### BRIEF DESCRIPTION OF THE DRAWINGS

FIG. 1 is a digital twin block diagram of dynamic response and stiffness prediction of a gear;

FIG. 2 is a diagram of a lumped parameter dynamic model of a gear;

FIG. 3 is a result diagram of a dynamic meshing force of a gear;

FIG. 4 is a result diagram of acceleration prediction;

FIGS. 5A-5F is partial result diagrams of dynamic response prediction of a gear;

FIGS. 6A-6C is partial result diagrams of stiffness degradation prediction of a gear.

### DETAILED DESCRIPTION OF THE EMBODIMENTS

The present disclosure is further illustrated and described below with reference to the accompanying drawings and specific embodiments.

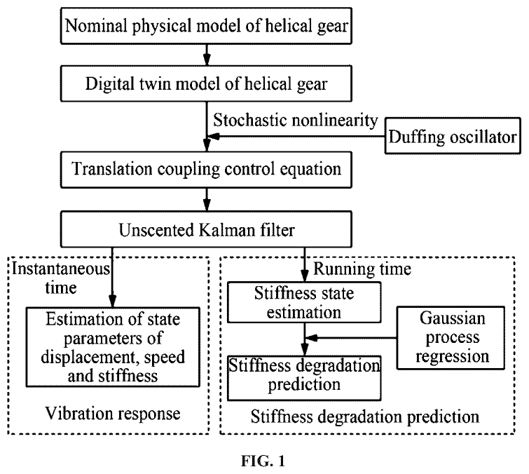

In a preferred embodiment, a method for predicting vibration response and stiffness degradation of a helical gear is provided. The method includes: establishing a lumped parameter dynamic model of a gear system according to a meshing condition of a pair of gears; considering that the gear system is a multi-degree-of-freedom system under the action of a deterministic force and a random force, establishing a digital twin model of the system at multiple time scales of characteristic time and running time; calculating a translation-vibration coupling control equation; establishing a grey box model by combining unscented Kalman filter with machine learning; performing combined state parameter estimation on collected data to construct a state prediction framework; and predicting stiffness degradation at a running time scale. The response of a nonlinear multi-degree-of-freedom system can be predicted, and the residual stiffness of the gear is predicted through the collected data, which provides a theoretical support for the safe use of the gear. As shown in FIG. 1, the basic steps of the method are as follows.
S1. Design parameters of a pair of intermeshing gears to be predicted are acquired, then a dynamic model of a helical gear meshing pair is established, and then a digital twin model is established by taking the dynamic model as a nominal physical model, and a Duffing oscillator is introduced into the digital twin model to simulate stochastic nonlinearity in a system, thereby establishing a translation-vibration coupling control equation.
S2. Based on an unscented Kalman filter algorithm, state parameters of displacement, speed and stiffness are estimated by using simulated acceleration data obtained from the translation-vibration coupling control equation to obtain an estimated value of each state parameter in an instantaneous time scale and an evolution process of stiffness in a running time scale.
S3. Evolution process data of the stiffness at the running time scale is used as training data to train a machine learning model to form a stiffness state prediction model, which is configured to predict the stiffness degradation of the helical gear meshing pair in the future.

The specific implementation modes of the above steps in the embodiment of the present disclosure are described in detail below.

In the embodiment of the present disclosure, specific implementation sub-steps of Step S1 include S1-1 to S1-4, and the introduction of the specific process is as follows.
S1-1. Design parameters of the pair of intermeshing gears to be predicted are acquired, including the number of teeth of a gear, a module, a pressure angle, a helix angle, a contact ratio, a tooth width, a base circle radius, a rated load, a rated speed, an input torque, and an output torque.

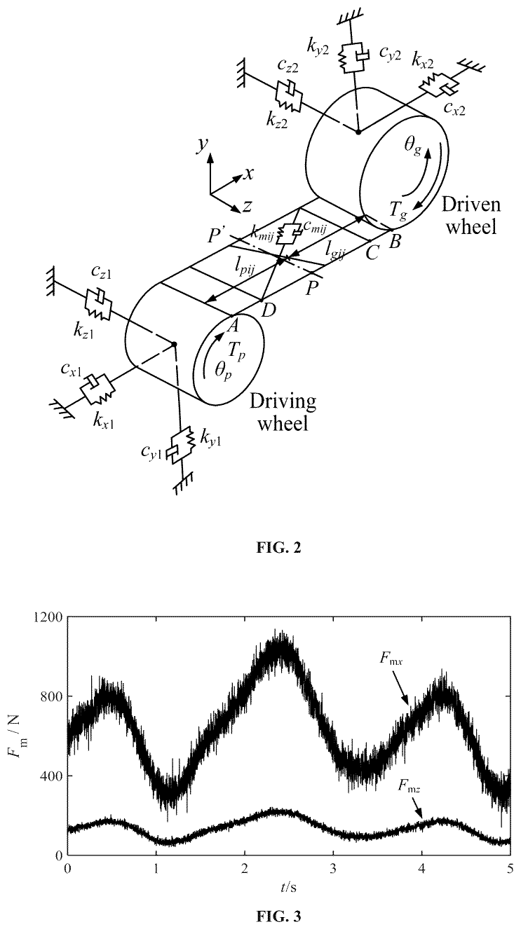

It should be noted that the design parameters of the helical gear are acquired from gear design data.
S1-2. A Cartesian coordinate system is established in a direction shown in FIG. 2. To simplify the research, it is assumed that the driving wheel and the driven wheel have the same equivalent supporting stiffness and damping. According to the design parameters of the helical gear meshing pair and Newton's second law, a lumped parameter dynamic model (Hereinafter referred to as dynamic model) of an eight-degree-of-freedom helical gear system is established according to design parameters of the helical gear meshing pair and Newton's second law, and a meshing force of a helical gear system is solved.

An expression of the dynamic model is as follows:

$$\{ \begin{matrix}{m}_{1} {\ddot{x}}_{1} ( t ) + {c}_{x 1} {\dot{x}}_{1} ( t ) + {k}_{x 1} {x}_{1} = - {\sum }_{j = 1}^{n} {F}_{mxj} ( t ) \\ {m}_{2} {\ddot{x}}_{2} ( t ) + {c}_{x 2} {\dot{x}}_{2} ( t ) + {k}_{x 2} {x}_{2} = {\sum }_{j = 1}^{n} {F}_{mxj} ( t ) \\ {m}_{1} {\ddot{y}}_{1} ( t ) + {c}_{y 1} {\dot{y}}_{1} ( t ) + {k}_{y 1} {y}_{1} = 0 \\ {m}_{2} {\ddot{y}}_{2} ( t ) + {c}_{y 2} {\dot{y}}_{2} ( t ) + {k}_{y 2} {y}_{2} = 0 \\ {m}_{1} {\ddot{z}}_{1} ( t ) + {c}_{z 1} {\dot{z}}_{1} ( t ) + {k}_{z 1} {z}_{1} = - {\sum }_{j = 1}^{n} {F}_{mzj} ( t ) \\ {m}_{2} {\ddot{z}}_{2} ( t ) + {c}_{z 2} {\dot{z}}_{2} ( t ) + {k}_{z 2} {z}_{2} = {\sum }_{j = 1}^{n} {F}_{mzj} ( t ) \\ {I}_{1} {\ddot{θ}}_{1} + {\sum }_{j = 1}^{n} {F}_{mxj} ( t ) {R}_{b 1} - {T}_{1} = 0 \\ {I}_{2} {\ddot{θ}}_{2} + {\sum }_{j = 1}^{n} {F}_{mxj} ( t ) {R}_{b 2} - {T}_{2} = 0\end{matrix} \qquad ( 1 )$$

where xᵢ, yᵢ and zᵢ are translational displacements of a gear i in a direction of a meshing line, a direction perpendicular to the meshing line, and an axial direction, respectively; mᵢ is mass of the gear i, kₓᵢ, k_{yi} and k_{zi} are stiffness of the gear i in the direction of the meshing line, the direction perpendicular to the meshing line, and the axial direction, respectively; cₓᵢ, c_{yi} and c_{zi} are damping of the gear i in the direction of the meshing line, the direction perpendicular to the meshing line, and the axial direction, respectively; i=1, 2 represents a driving gear and a driven gear, respectively; Fₘₓⱼ(t) and F_{mzj}(t) are dynamic meshing forces of a j^{th} tooth meshed at time t in the direction of the meshing line and the axial direction, respectively; j=1, 2, . . . , n; n is the number of meshed teeth; I₁ and I₂ are moment of inertia of the driving wheel and the driven wheel, respectively; θ₁ and θ₂ are rotation angles of the driving wheel and the driven wheel, respectively, T₁ and T₂ are an input torque and an output torque, respectively, and R_{b1} and R_{b2} are base circle radii of the driving wheel and the driven wheel, respectively.

It should be noted that one point or two points on a parameter symbol represent a first derivative or a second derivative of the parameter, respectively, belonging to the common expression in mathematics.
S1-3. A six-degree-of-freedom translation-vibration digital twin model of the helical gear system is established by taking the dynamic model as a nominal system of digital twin. Considering the multi-degree-of-freedom system under the deterministic force and the random force, the digital twin model of the helical gear system is in a form of:

$$M ( {τ}_{s} ) \frac{{\partial }^{2} X ( t , {τ}_{s} )}{\partial {t}^{2}} + C ( {τ}_{s} ) \frac{\partial X ( t , {τ}_{s} )}{\partial t} + K ( {τ}_{s} ) X ( t , {τ}_{s} ) + G ( t , {τ}_{s} ) = F ( t , {τ}_{s} ) + Ξ \dot{W} \qquad ( 2 )$$

where M(τₛ), C(τₛ) and K(τₛ) are a mass matrix, a damping matrix and a stiffness matrix of the gear, respectively, which are all related to running time τₛ; Ξ is a noise strength matrix, \dot{W} is a random load, G, F and X are stochastic nonlinearity, a meshing force and a translational displacement of the helical gear system, respectively, which are all related to the instantaneous time t and the running time τₛ.
S1-4. Based on the six-degree-of-freedom translation-vibration digital twin model, a Duffing oscillator is added to the driven wheel in the direction perpendicular to the meshing line (y₂ direction) to simulate the stochastic nonlinearity G in the system, thus establishing the translation-vibration coupling control equation, which is in the form of:

$$\{ \begin{matrix}\begin{matrix}{m}_{1} {\ddot{x}}_{1} + ( {c}_{x 1} + {c}_{x 2} ) {\dot{x}}_{1} - {c}_{x 2} {\dot{x}}_{2} + \\ ( {k}_{x 1} + {k}_{x 2} ) {x}_{1} - {k}_{x 2} {x}_{2} = - {\sum }_{j = 1}^{n} {F}_{mxj} + {ξ}_{1} {\dot{w}}_{1}\end{matrix} \\ \begin{matrix}{m}_{2} {\ddot{x}}_{2} - {c}_{x 2} {\dot{x}}_{1} + ( {c}_{x 2} + {c}_{y 1} ) {\dot{x}}_{2} - {c}_{y 1} {\dot{y}}_{1} - {k}_{x 2} {x}_{1} + \\ ( {k}_{x 2} + {k}_{y 1} ) {x}_{2} - {k}_{y 1} {y}_{1} = - {\sum }_{j = 1}^{n} {F}_{mxj} + {ξ}_{2} {\dot{w}}_{2}\end{matrix} \\ \begin{matrix}{m}_{1} {\ddot{y}}_{1} - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} - {k}_{y 2} {y}_{2} = {ξ}_{3} {\dot{w}}_{3}\end{matrix} \\ \begin{matrix}{m}_{2} {\ddot{y}}_{2} - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( {k}_{y 2} + {k}_{z 1} ) {y}_{2} - {k}_{z 1} {z}_{1} + {{α}_{do} ( {y}_{2} - {y}_{1} )}^{3} = {ξ}_{4} {\dot{w}}_{4}\end{matrix} \\ \begin{matrix}{m}_{1} {\ddot{z}}_{1} - {c}_{z 1} {\dot{y}}_{2} + ( {c}_{z 1} + {c}_{z 2} ) {\dot{z}}_{1} - {c}_{z 2} {\dot{z}}_{2} - {k}_{z 1} {y}_{2} + \\ ( {k}_{z 1} + {k}_{z 2} ) {z}_{1} - {k}_{z 2} {z}_{2} = - {\sum }_{j = 1}^{n} {F}_{mzj} + {ξ}_{5} {\dot{w}}_{5}\end{matrix} \\ \begin{matrix}{m}_{2} {\ddot{z}}_{2} - {c}_{z 1} {\dot{z}}_{1} + {c}_{z 2} {\dot{z}}_{2} - {k}_{z 1} {z}_{1} + \\ {k}_{z 2} {z}_{2} = - {\sum }_{j = 1}^{n} {F}_{mzj} + {ξ}_{6} {\dot{w}}_{6}\end{matrix}\end{matrix} \qquad ( 3 )$$

where α_{do} is a Duffing oscillator factor that simulates the stochastic nonlinearity in the helical gear system, ξₗ\dot{w}ₗ represents noise strength corresponding to the degree of freedom l, and ξₗ and \dot{w}ₗ are noise strength and a random load, respectively, where l=1, 2, . . . , 6.

It should be noted that the above digital twin model has two different time scales, i.e., instantaneous time t, and running time τₛ. The instantaneous time t is characteristic time, and the stiffness degradation process is slow, so the time step of the running time is large. In the embodiment of the present disclosure, the time step of the instantaneous time t is seconds, and the time step of the running time τₛ is days. The instantaneous time scale is used for state parameter estimation, while the running time scale is used for stiffness degradation prediction.

In an embodiment, the specific implementation sub-steps of Step S2 include S2-1 to S2-3, and the introduction of the specific process is as follows.
S2-1. An acceleration equation is established based on the translation-vibration coupling control equation, simulated acceleration data of the helical gear is acquired by solving the acceleration equation, where the acceleration equation is represented as follows:

$$A = - \{ \begin{matrix}\frac{1}{{m}_{1}} ( ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} ) \\ \begin{matrix}\frac{1}{{m}_{2}} ( - {c}_{x 2} {\dot{x}}_{1} + ( {c}_{x 2} + {c}_{y 1} ) {\dot{x}}_{2} - \\ {c}_{y 1} {\dot{y}}_{1} - {k}_{x 2} {x}_{1} + ( {k}_{x 2} + {k}_{y 1} ) {x}_{2} - {k}_{y 1} {y}_{1} )\end{matrix} \\ \begin{matrix}\frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} + {k}_{y 2} {y}_{2} )\end{matrix} \\ \begin{matrix}\frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( - {k}_{y 2} + {k}_{z 1} ) {y}_{2} - {k}_{z 1} {z}_{1} + {{α}_{do} ( {y}_{2} - {y}_{1} )}^{3} )\end{matrix} \\ \begin{matrix}\frac{1}{{m}_{1}} ( - {c}_{z 1} {\dot{y}}_{2} + ( {c}_{z 1} + {c}_{z 2} ) {\dot{z}}_{1} - \\ {c}_{z 2} {\dot{z}}_{2} - {k}_{z 1} {y}_{2} + ( {k}_{z 1} + {k}_{z 2} ) {z}_{1} - {k}_{z 2} {z}_{2} )\end{matrix} \\ \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix} \qquad ( 4 )$$

in the expression, A represents simulated acceleration data in the matrix form.
S2-2. Based on the obtained simulated acceleration data and the unscented Kalman filter algorithm, the state parameters of displacement, speed and stiffness at different instantaneous time at the instantaneous time scale are estimated in an iterative manner by a “Euler-Maruyama” method, where a formula is as follows:

$${y}_{k + 1} = {y}_{k} + a ( {t}_{k + 1} , {y}_{k + 1} ) Δ t + b ( {t}_{k + 1} , {y}_{k + 1} ) Δ w \qquad ( 5 )$$

y is a state space vector composed of a displacement, speed and stiffness; yₖ₊₁ and yₖ are state space vectors y corresponding to a following instantaneous time tₖ₊₁ and a previous instantaneous time tₖ, respectively, and a time step of iteration is Δt=tₖ₊₁−tₖ; Δw is a variation amount of an independent Wiener process w between the previous instantaneous time and the following instantaneous time; a and b are a drift matrix and a diffusion matrix, respectively.

In an embodiment of the present disclosure, expressions of the drift matrix a and the diffusion matrix b are as follows:

$$a = [ \begin{matrix}{\dot{x}}_{1} \\ \frac{- {\sum }_{j = 1}^{n} {F}_{mxj}}{{m}_{1}} - \frac{1}{{m}_{1}} ( ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} ) \\ {\dot{x}}_{2} \\ \begin{matrix}\frac{- {\sum }_{j = 1}^{n} {F}_{mxj}}{{m}_{2}} - \frac{1}{{m}_{2}} ( - {c}_{x 2} {\dot{x}}_{1} + ( {c}_{x 2} + {c}_{y 1} ) {\dot{x}}_{2} - \\ {c}_{y 1} {\dot{y}}_{1} - {k}_{x 2} {x}_{1} + ( {k}_{x 2} + {k}_{y 1} ) {x}_{2} - {k}_{y 1} {y}_{1} )\end{matrix} \\ \begin{matrix}{\dot{y}}_{1} \\ \begin{matrix}- \frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} - {k}_{y 2} {y}_{2} )\end{matrix} \\ {\dot{y}}_{2}\end{matrix} \\ \begin{matrix}- \frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( - {k}_{y 2} + {k}_{z 1} ) {y}_{2} - {k}_{z 1} {z}_{1} + {{α}_{do} ( {y}_{2} - {y}_{1} )}^{3} )\end{matrix} \\ \begin{matrix}{\dot{z}}_{1} \\ \begin{matrix}\frac{- {\sum }_{j = 1}^{n} {F}_{mzj}}{{m}_{1}} - \frac{1}{{m}_{1}} ( - {c}_{z 1} {\dot{y}}_{2} + ( {c}_{z 1} + {c}_{z 2} ) {\dot{z}}_{1} - \\ {c}_{z 2} {\dot{z}}_{2} - {k}_{z 1} {y}_{2} + ( {k}_{z 1} + {k}_{z 2} ) {z}_{1} - {k}_{z 2} {z}_{2} )\end{matrix} \\ {\dot{z}}_{2}\end{matrix} \\ \frac{- {\sum }_{j = 1}^{n} {F}_{mzj}}{{m}_{2}} - \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix} ] \qquad ( 6 )$$

$$b = [ \begin{matrix}{0}_{1 \times 6} \\ \frac{{ξ}_{1}}{{m}_{1}} , {0}_{1 \times 5} \\ {0}_{1 \times 6} \\ 0 , \frac{{ξ}_{2}}{{m}_{2}} , {0}_{1 \times 4} \\ \begin{matrix}{0}_{1 \times 6} \\ {0}_{1 \times 2} , \frac{{ξ}_{3}}{{m}_{1}} , {0}_{1 \times 3} \\ {0}_{1 \times 6}\end{matrix} \\ {0}_{1 \times 3} , \frac{{ξ}_{4}}{{m}_{2}} , {0}_{1 \times 2} \\ \begin{matrix}{0}_{1 \times 6} \\ {0}_{1 \times 4} , \frac{{ξ}_{5}}{{m}_{1}} , 0 \\ {0}_{1 \times 6}\end{matrix} \\ {0}_{1 \times 5} , \frac{{ξ}_{6}}{{m}_{2}}\end{matrix} ] . \qquad ( 7 )$$

S2-3. The stiffness matrix is an attenuation function in a running time period, which indicates the loss of system stiffness in a long time. To predict the stiffness degradation process of the system, a stiffness degradation function at the running time scale needs to be constructed, and then an evolution process of the stiffness at the running time scale is estimated in an iterative manner through an unscented Kalman filtering algorithm based on the stiffness attenuation function, where a form of the stiffness attenuation function constructed in the present disclosure is as follows:

$$K ( {τ}_{s} ) = {K}_{0} {e}^{- {α}_{k} {τ}_{s}} \frac{( 1 + {ε}_{k} cos ( {β}_{k} {τ}_{s} ) )}{( 1 + {ε}_{k} )} \qquad ( 8 )$$

where K₀ is initial stiffness of the helical gear system, K(τₛ) is stiffness of the helical gear system in the running time τₛ, αₖ is a stiffness attenuation factor, and εₖ and βₖ are stiffness attenuation form coefficients.

In an embodiment of the present disclosure, in Step S3, the machine learning model employs a Gaussian process regression model, an input of which is the running time, and an output is a predicted value of stiffness.

Therefore, a method for predicting vibration response and stiffness degradation of a helical gear can fill the gap of the multi-degree-of-freedom system of the gear in dynamic response and stiffness degradation prediction at different time scales. The prediction method in S1 to S3 will be applied to a specific embodiment below to show the specific effects thereof.

### Embodiment

The flow of the method for predicting vibration response and stiffness degradation of a helical gear in this embodiment is specifically as described in S1 to S3 above, and thus will not be completely repeated. The following mainly describes its specific implementation form and technical effect.

As shown in FIG. 1, in this embodiment, a method for predicting vibration response and stiffness degradation of a helical gear is as follows.

Main parameters of a pair of intermeshing gears in a gearbox for a ship are acquired through gear design drawings and other data, as shown in Table 1:

TABLE 1

| | Driving gear | Driven gear |
|---|---|---|
| The number of teeth | Z₁ = 36 | Z₂ = 48 |
| mass/(×10² kg) | m₁ = 0.68 | m₂ = 1.81 |

| | |
|---|---|
| Density/(kg/m³) | ρi = 7850 |
| Support stiffness/((N/m) | kₓᵢ = k_{yi} = k_{zi} = 2.0 × 10⁸ |
| Support damping/((N · s/m) | cₓᵢ = c_{yi} = c_{zi} = 2.8 × 10⁶ |
| Duffing oscillator factor | α_{do} = 100 |

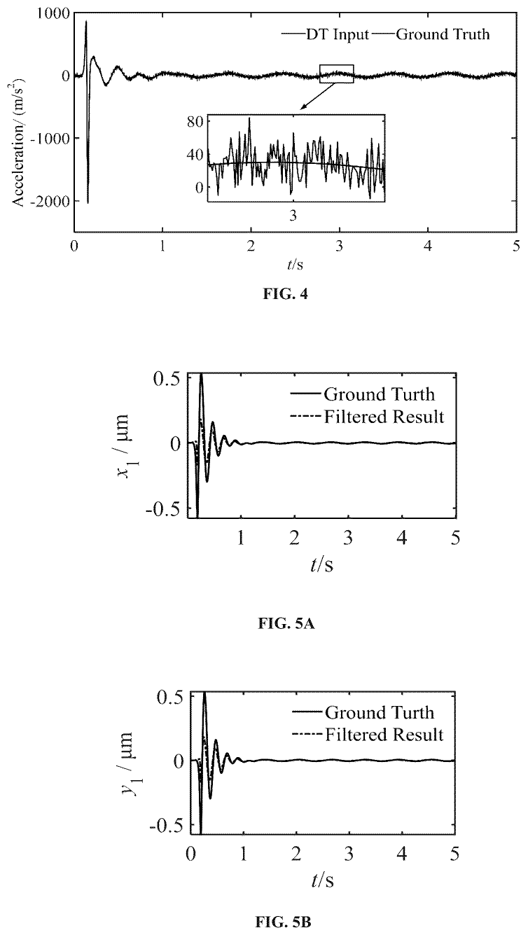

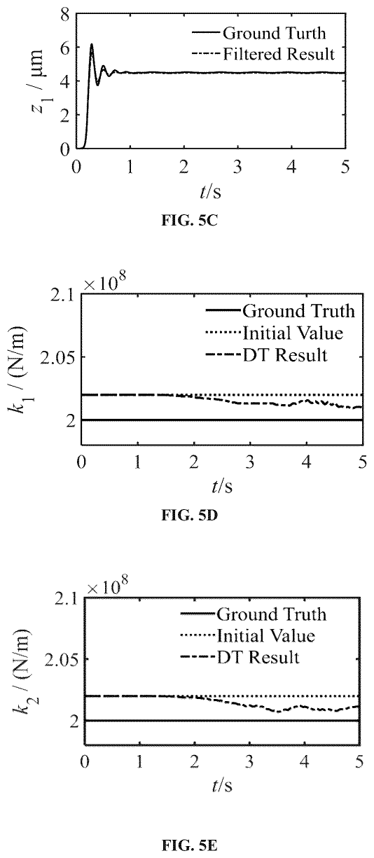

According to the gear dynamic model, the dynamic meshing force of the gear is calculated, as shown in FIG. 3. According to the parameters in Table 1, when the Gaussian white noise is 50, an acceleration numerical curve obtained by expressions (1) to (4) is shown in FIG. 4. The result shows that the acceleration oscillates violently at an initial stage of transmission, enters a stable oscillation stage after 1 s, and then is kept at −30.08˜30.08 m/s² after entering a stable transmission stage.

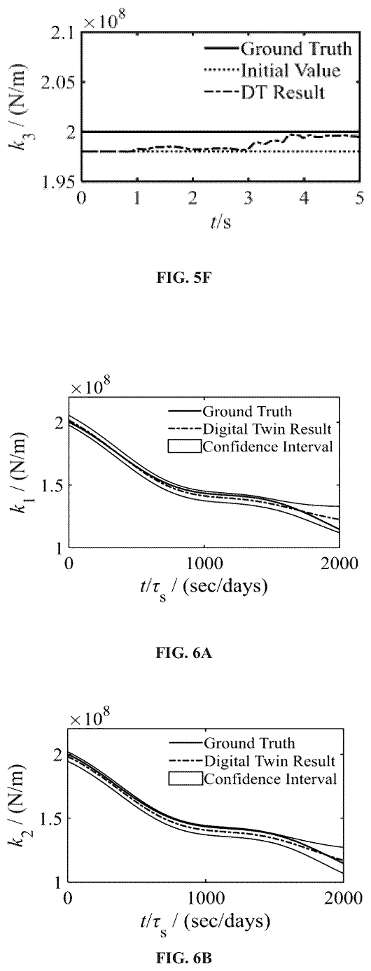

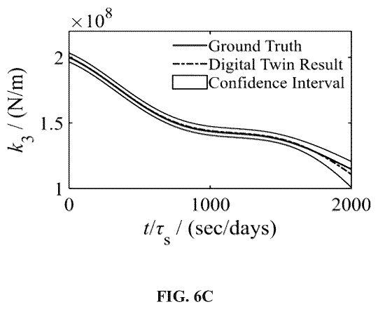

To describe the performance of the digital twin system, according to the above expressions (5)-(7) and Table 1, combined with unscented Kalman filter algorithm and Gaussian process regression, the system parameters are predicted, and the prediction results are shown in FIGS. 5A-5F and FIGS. 6A-6C. The result shows that the vibration waveforms of displacement and speed are similar to acceleration, and the estimation accuracy of stiffness is close to 98%. The provided method has high accuracy in predicting the system state.

Assuming that the sensor measurement is available in a fixed time interval, the stiffness degradation can be predicted at the running time scale according to the expression (8), parameters αₖ=5×10⁻⁵, εₖ=0.04 and βₖ=8×10⁻⁴ are taken, the degradation of stiffness with the time is estimated based on machine learning and acquired data dots, and a prediction result is shown in FIGS. 5A-5F. The result shows that predicted results of k₂, k₃ and k₅ are basically consistent with the true values in a confidence interval, while k₁ and k₆ deviate from the true values at the end, but are basically consistent. A shadow area describes 98% of the confidence interval, which means that this method can be used to collect more data and make more accurate decisions. Therefore, the provided digital twin system can be configured to predict the stiffness and system response in the future time step, and carry out predictive maintenance of the system.

The embodiment described above is only a preferred scheme of the present disclosure, and is not intended to limit the present disclosure. Those skilled in the related art can make various changes and modifications without departing from the spirit and scope of the present disclosure. Therefore, all technical solutions obtained by equivalent substitution or equivalent transformation shall fall within the scope of protection of the present disclosure.

What is claimed is:

1. A method for predicting vibration response and stiffness degradation of a helical gear, comprising:
S1: acquiring design parameters of a pair of intermeshing gears to be predicted, and then establishing a dynamic model of a helical gear meshing pair, and then establishing a digital twin model with the dynamic model as a nominal physical model, and introducing a Duffing oscillator into the digital twin model to simulate stochastic nonlinearity in a system, thereby establishing a translation-vibration coupling control equation;
S2: based on an unscented Kalman filter algorithm, estimating state parameters of displacement, speed and stiffness by using simulated acceleration data obtained from the translation-vibration coupling control equation, to obtain an estimated value of each state parameter in an instantaneous time scale and an evolution process of stiffness in a running time scale; and
S3: training a machine learning model with evolution process data of the stiffness at the running time scale as training data, to form a stiffness state prediction model, which is configured to predict the stiffness degradation of the helical gear meshing pair in future.

2. The method for predicting vibration response and stiffness degradation of the helical gear according to claim 1, wherein implementation steps of Step S1 comprises:
S1-1: acquiring design parameters of the pair of intermeshing gears to be predicted, comprising a number of teeth of a gear, a module, a pressure angle, a helix angle, a contact ratio, a tooth width, a radius of base circle, a rated load, a rated speed, an input torque, and an output torque;
S1-2: establishing a lumped parameter dynamic model of an eight-degree-of-freedom helical gear system according to design parameters of the helical gear meshing pair and Newton's second law, and solving a meshing force of the helical gear system;
wherein the dynamic model is as follows:
$$\{ \begin{matrix}{m}_{1} {\ddot{x}}_{1} ( t ) + {c}_{x 1} {\dot{x}}_{1} ( t ) + {k}_{x 1} {x}_{1} = - {\sum }_{j = 1}^{n} {F}_{mxj} ( t ) \\ {m}_{2} {\ddot{x}}_{2} ( t ) + {c}_{x 2} {\dot{x}}_{2} ( t ) + {k}_{x 2} {x}_{2} = {\sum }_{j = 1}^{n} {F}_{mxj} ( t ) \\ {m}_{1} {\ddot{y}}_{1} ( t ) + {c}_{y 1} {\dot{y}}_{1} ( t ) + {k}_{y 1} {y}_{1} = 0 \\ {m}_{2} {\ddot{y}}_{2} ( t ) + {c}_{y 2} {\dot{y}}_{2} ( t ) + {k}_{y 2} {y}_{2} = 0 \\ {m}_{1} {\ddot{z}}_{1} ( t ) + {c}_{z 1} {\dot{z}}_{1} ( t ) + {k}_{z 1} {z}_{1} = - {\sum }_{j = 1}^{n} {F}_{mzj} ( t ) \\ {m}_{2} {\ddot{z}}_{2} ( t ) + {c}_{z 2} {\dot{z}}_{2} ( t ) + {k}_{z 2} {z}_{2} = {\sum }_{j = 1}^{n} {F}_{mzj} ( t ) \\ {I}_{1} {\ddot{θ}}_{1} + {\sum }_{j = 1}^{n} {F}_{mxj} ( t ) {R}_{b 1} - {T}_{1} = 0 \\ {I}_{2} {\ddot{θ}}_{2} + {\sum }_{j = 1}^{n} {F}_{mxj} ( t ) {R}_{b 2} - {T}_{2} = 0\end{matrix}$$
wherein xᵢ, yᵢ and zᵢ are translational displacements of a gear i in a direction of a meshing line, a direction perpendicular to the meshing line, and an axial direction, respectively; mᵢ is mass of the gear i, kₓᵢ, k_{yi} and k_{zi} are stiffness of the gear i in the direction of the meshing line, the direction perpendicular to the meshing line, and the axial direction, respectively; cₓᵢ, c_{yi} and c_{zi} are damping of the gear i in the direction of the meshing line, the direction perpendicular to the meshing line, and the axial direction, respectively; i=1, 2 represents a driving gear and a driven gear, respectively; Fₘₓⱼ(t) and F_{mzj}(t) are dynamic meshing forces of a j^{th} tooth meshed at a time t in the direction of the meshing line and the axial direction, respectively, j=1, 2, . . . , n, n is a number of meshed teeth; I₁ and I₂ are moment of inertia of the driving wheel and the driven wheel, respectively; θ₁ and θ₂ are angles of rotation of the driving wheel and the driven wheel, respectively, T₁ and T₂ are an input torque and an output torque, respectively; R_{b1} and R_{b2} are radii of base circles of the driving wheel and the driven wheel, respectively; and one point or two points on a parameter symbol represent a first derivative or a second derivative of the parameter, respectively;
S1-3: establishing a six-degree-of-freedom translation-vibration digital twin model of the helical gear system with the dynamic model as a nominal system of digital twin, which is in a form of:
$$M ( {τ}_{s} ) \frac{{\partial }^{2} X ( t , {τ}_{s} )}{\partial {t}^{2}} + C ( {τ}_{s} ) \frac{\partial X ( t , {τ}_{s} )}{\partial t} + K ( {τ}_{s} ) X ( t , {τ}_{s} ) + G ( t , {τ}_{s} ) = F ( t , {τ}_{s} ) + Ξ \dot{W}$$
wherein M(τₛ), C(τₛ) and K(τₛ) are a mass matrix, a damping matrix and a stiffness matrix of the gear, respectively, which are all related to a running time τₛ; Ξ is a noise strength matrix, \dot{W} is a random load, G, F and X are stochastic nonlinearity, a meshing force and a translational displacement of the helical gear system, respectively, which are all related to an instantaneous time t and the running time τₛ;
S1-4: based on the six-degree-of-freedom translation-vibration digital twin model, adding a Duffing oscillator to the driven wheel in the direction perpendicular to the meshing line to simulate the stochastic nonlinearity G in the system, thus establishing the translation-vibration coupling control equation, which is in a form of:
$$\{ \begin{matrix}\begin{matrix}{m}_{1} {\ddot{x}}_{1} + ( {c}_{x 1} + {c}_{x 2} ) {\dot{x}}_{1} - {c}_{x 2} {\dot{x}}_{2} + \\ ( {k}_{x 1} + {k}_{x 2} ) {x}_{1} - {k}_{x 2} {x}_{2} = - {\sum }_{j = 1}^{n} {F}_{mxj} + {ξ}_{1} {\dot{w}}_{1}\end{matrix} \\ \begin{matrix}{m}_{2} {\ddot{x}}_{2} - {c}_{x 2} {\dot{x}}_{1} + ( {c}_{x 2} + {c}_{y 1} ) {\dot{x}}_{2} - {c}_{y 1} {\dot{y}}_{1} - {k}_{x 2} {x}_{1} + \\ ( {k}_{x 2} + {k}_{y 1} ) {x}_{2} - {k}_{y 1} {y}_{1} = - {\sum }_{j = 1}^{n} {F}_{mxj} + {ξ}_{2} {\dot{w}}_{2}\end{matrix} \\ \begin{matrix}{m}_{1} {\ddot{y}}_{1} - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} - {k}_{y 2} {y}_{2} = {ξ}_{3} {\dot{w}}_{3}\end{matrix} \\ \begin{matrix}{m}_{2} {\ddot{y}}_{2} - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( {k}_{y 2} + {k}_{z 1} ) {y}_{2} - {k}_{z 1} {z}_{1} + {{α}_{do} ( {y}_{2} - {y}_{1} )}^{3} = {ξ}_{4} {\dot{w}}_{4}\end{matrix} \\ \begin{matrix}{m}_{1} {\ddot{z}}_{1} - {c}_{z 1} {\dot{y}}_{2} + ( {c}_{z 1} + {c}_{z 2} ) {\dot{z}}_{1} - {c}_{z 2} {\dot{z}}_{2} - {k}_{z 1} {y}_{2} + \\ ( {k}_{z 1} + {k}_{z 2} ) {z}_{1} - {k}_{z 2} {z}_{2} = - {\sum }_{j = 1}^{n} {F}_{mzj} + {ξ}_{5} {\dot{w}}_{5}\end{matrix} \\ \begin{matrix}{m}_{2} {\ddot{z}}_{2} - {c}_{z 1} {\dot{z}}_{1} + {c}_{z 2} {\dot{z}}_{2} - {k}_{z 1} {z}_{1} + \\ {k}_{z 2} {z}_{2} = - {\sum }_{j = 1}^{n} {F}_{mzj} + {ξ}_{6} {\dot{w}}_{6}\end{matrix}\end{matrix}$$
wherein α_{do} is a Duffing oscillator factor that simulates stochastic nonlinearity in the helical gear system, and ξₗ\dot{w}ₗ represents noise strength corresponding to a degree of freedom l, l=1, 2, . . . , 6.

3. The method for predicting vibration response and stiffness degradation of the helical gear according to claim 1, wherein the design parameters of the helical gear are acquired from gear design data.

4. The method for predicting vibration response and stiffness degradation of the helical gear according to claim 1, wherein the digital twin model has two different time scales, which are an instantaneous time t and a running time τₛ, wherein a time step of the instantaneous time t is seconds, and a time step of the running time τₛ is days; the instantaneous time scale is used for state parameter estimation, and the running time scale is used for stiffness degradation prediction.

5. The method for predicting vibration response and stiffness degradation of the helical gear according to claim 2, wherein implementation steps of Step S2 comprise:
S2-1: establishing an acceleration equation based on the translation-vibration coupling control equation, acquiring simulated acceleration data of the helical gear by solving the acceleration equation, wherein the acceleration equation is represented as follows:
$$A = - \{ \begin{matrix}\frac{1}{{m}_{1}} ( ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} ) \\ \begin{matrix}\frac{1}{{m}_{2}} ( - {c}_{x 2} {\dot{x}}_{1} + ( {c}_{x 2} + {c}_{y 1} ) {\dot{x}}_{2} - \\ {c}_{y 1} {\dot{y}}_{1} - {k}_{x 2} {x}_{1} + ( {k}_{x 2} + {k}_{y 1} ) {x}_{2} - {k}_{y 1} {y}_{1} )\end{matrix} \\ \begin{matrix}\frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} + {k}_{y 2} {y}_{2} )\end{matrix} \\ \begin{matrix}\frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( - {k}_{y 2} + {k}_{z 1} ) {y}_{2} - {k}_{z 1} {z}_{1} + {{α}_{do} ( {y}_{2} - {y}_{1} )}^{3} )\end{matrix} \\ \begin{matrix}\frac{1}{{m}_{1}} ( - {c}_{z 1} {\dot{y}}_{2} + ( {c}_{z 1} + {c}_{z 2} ) {\dot{z}}_{1} - \\ {c}_{z 2} {\dot{z}}_{2} - {k}_{z 1} {y}_{2} + ( {k}_{z 1} + {k}_{z 2} ) {z}_{1} - {k}_{z 2} {z}_{2} )\end{matrix} \\ \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix}$$
in the equation, A represents simulated acceleration data in a matrix form;
S2-2: based on the obtained simulated acceleration data and the unscented Kalman filter algorithm, estimating the state parameters of displacement, speed and stiffness at different instantaneous time at the instantaneous time scale in an iterative manner by an “Euler-Maruyama” method, wherein an expression is as follows:
$${y}_{k + 1} = {y}_{k} + a ( {t}_{k + 1} , {y}_{k + 1} ) Δ t + b ( {t}_{k + 1} , {y}_{k + 1} ) Δ w ,$$
wherein y is a state space vector composed of a displacement, speed and stiffness, yₖ and yₖ₊₁ are state space vectors y corresponding to a previous instantaneous time tₖ and a following instantaneous time tₖ₊₁, respectively, and a time step of iteration is Δt=tₖ₊₁−tₖ; Δw is a variation amount of an independent Wiener process w between the previous instantaneous time and the following instantaneous time; a and b are a drift matrix and a diffusion matrix, respectively;
S2-3: constructing a stiffness degradation function at the running time scale, and then estimating the evolution process of stiffness at the running time scale in an iterative manner through an unscented Kalman filtering algorithm based on the stiffness attenuation function, wherein a form of the stiffness attenuation function is:
$$K ( {τ}_{s} ) = {K}_{0} {e}^{- {α}_{k} {τ}_{s}} \frac{( 1 + {ε}_{k} cos ( {β}_{k} {τ}_{s} ) )}{( 1 + {ε}_{k} )} ,$$
wherein K₀ is initial stiffness of the helical gear system, K(τₛ) is stiffness of the helical gear system in a running time τₛ, αₖ is a stiffness attenuation factor, and εₖ and βₖ are stiffness attenuation form coefficients.

6. The method for predicting vibration response and stiffness degradation of the helical gear according to claim 5, wherein expressions of the drift matrix a and the diffusion matrix b are as follows:
$$a = [ \begin{matrix}{\dot{x}}_{1} \\ \frac{- {\sum }_{j = 1}^{n} {F}_{mxj}}{{m}_{1}} - \frac{1}{{m}_{1}} ( ( {c}_{x 1} + {c}_{x 2} ) {\dot{x}}_{1} - {c}_{x 2} {\dot{x}}_{2} + ( {k}_{x 1} + {k}_{x 2} ) {x}_{1} - {k}_{x 2} {x}_{2} ) \\ {\dot{x}}_{2} \\ \begin{matrix}\frac{- {\sum }_{j = 1}^{n} {F}_{mxj}}{{m}_{2}} - \frac{1}{{m}_{2}} ( - {c}_{x 2} {\dot{x}}_{1} + ( {c}_{x 2} + {c}_{y 1} ) {\dot{x}}_{2} - \\ {c}_{y 1} {\dot{y}}_{1} - {k}_{x 2} {x}_{1} + ( {k}_{x 2} + {k}_{y 1} ) {x}_{2} - {k}_{y 1} {y}_{1} )\end{matrix} \\ \begin{matrix}{\dot{y}}_{1} \\ \begin{matrix}- \frac{1}{{m}_{1}} ( - {c}_{y 1} {\dot{x}}_{2} + ( {c}_{y 1} + {c}_{y 2} ) {\dot{y}}_{1} - {c}_{y 2} {\dot{y}}_{2} - {k}_{y 1} {x}_{2} + \\ ( {k}_{y 1} + {k}_{y 2} ) {y}_{1} - {k}_{y 2} {y}_{2} )\end{matrix} \\ {\dot{y}}_{2}\end{matrix} \\ \begin{matrix}- \frac{1}{{m}_{2}} ( - {c}_{y 2} {\dot{y}}_{1} + ( {c}_{y 2} + {c}_{z 1} ) {\dot{y}}_{2} - {c}_{z 1} {\dot{z}}_{1} - {k}_{y 2} {y}_{1} + \\ ( - {k}_{y 2} + {k}_{z 1} ) {y}_{2} - {k}_{z 1} {z}_{1} + {{α}_{do} ( {y}_{2} - {y}_{1} )}^{3} )\end{matrix} \\ \begin{matrix}{\dot{z}}_{1} \\ \begin{matrix}\frac{- {\sum }_{j = 1}^{n} {F}_{mzj}}{{m}_{1}} - \frac{1}{{m}_{1}} ( - {c}_{z 1} {\dot{y}}_{2} + ( {c}_{z 1} + {c}_{z 2} ) {\dot{z}}_{1} - \\ {c}_{z 2} {\dot{z}}_{2} - {k}_{z 1} {y}_{2} + ( {k}_{z 1} + {k}_{z 2} ) {z}_{1} - {k}_{z 2} {z}_{2} )\end{matrix} \\ {\dot{z}}_{2}\end{matrix} \\ \frac{- {\sum }_{j = 1}^{n} {F}_{mzj}}{{m}_{2}} - \frac{1}{{m}_{2}} ( - {c}_{z 1} {\dot{z}}_{1} + {c}_{z 2} {\dot{z}}_{2} - {k}_{z 1} {z}_{1} + {k}_{z 2} {z}_{2} )\end{matrix} ]$$
$$b = [ \begin{matrix}{0}_{1 \times 6} \\ \frac{{ξ}_{1}}{{m}_{1}} , {0}_{1 \times 5} \\ {0}_{1 \times 6} \\ 0 , \frac{{ξ}_{2}}{{m}_{2}} , {0}_{1 \times 4} \\ \begin{matrix}{0}_{1 \times 6} \\ {0}_{1 \times 2} , \frac{{ξ}_{3}}{{m}_{1}} , {0}_{1 \times 3} \\ {0}_{1 \times 6}\end{matrix} \\ {0}_{1 \times 3} , \frac{{ξ}_{4}}{{m}_{2}} , {0}_{1 \times 2} \\ \begin{matrix}{0}_{1 \times 6} \\ {0}_{1 \times 4} , \frac{{ξ}_{5}}{{m}_{1}} , 0 \\ {0}_{1 \times 6}\end{matrix} \\ {0}_{1 \times 5} , \frac{{ξ}_{6}}{{m}_{2}}\end{matrix} ] .$$

7. The method for predicting vibration response and stiffness degradation of the helical gear according to claim 1, wherein a Gaussian process regression model is used as the machine learning model, an input of the Gaussian process regression model is a running time, and an output of the Gaussian process regression model is a predicted value of the stiffness.
